(19) United States
(12) Patent Application Publication
(10) Pub. No.: US 2002/0041929 A1
(43) Pub. Date: Apr. 11, 2002

(54) Spray-spin coating method

(76) Inventor: Jean-Francois Magne, Kagiswil (CH)

Correspondence Address: Donald S. Dowden, Cooper & Dunham LLP, 1185 Avenue of the Americas, New York, NY, 10036, US

(21) Appl. No.: 09/726,706

(22) Filed: Nov. 30, 2000

(30) Foreign Application Priority Data
Oct. 11, 2000 (IB) PCT/IB00/01451

(51) Int. Cl. B05D 3/12; B05D 3/02; B05D 1/02; B05D 3/06

(52) U.S. Cl. 427/240; 427/425; 427/372.2; 427/553; 118/315; 118/314

(57) ABSTRACT

A method is described that combines the advantages of the dip-coating method with those of the spin-coating method, whereby at least one liquid coating composition is deposited on a substrate by means of at least one spray nozzle, and wherein said substrate is rotated (spinned) for some time at least after said liquid coating composition has been deposited. This method is particularly suited for the coating of ophthalmic substrates. Furthermore a device suitable for performing such a method is also disclosed.

### CROSS REFERENCE TO RELATED APPLICATIONS

This application claims the priority of the PCT application PCT/IB00/01451, filed Oct. 11, 2000, the disclosure of which is incorporated herein by reference in its entirety.

### TECHNICAL FIELD

The present invention relates to coating methods for various materials in particular to coating methods for coating optical lenses.

### BACKGROUND OF THE INVENTION

In the field of providing optical lenses with functional coatings, in particular two methods are applied, namely the so-called dip-coating method and the so-called spin-coating method.

The dip-coating method:

This classical method for coating ophthalmic lenses consists in dipping the lenses in a bath containing the coating solution. The thickness of the layer depends on the speed at which the sample is removed from the solution; the quicker the sample is removed from the solution the thicker is the resulting layer. Further important parameters influencing the thickness of the layers are the viscosity of the bath and the dried solid content.

The dip-coating method has a lot of disadvantages such as e.g. those stated below:

1. A lot of solution is required for allowing the sample to be dipped, because the bath has to be able to fully cover the sample and in addition, it has to be sufficiently large to avoid wall effect during the process. The amount needed to cover a sample is about 5 micro-liters, and the bath has to have a volume of more than 1 liter.

2. The dip-coating method is inconvenient for being used in a prescription process, because it allows only one kind of coating on both sides of a lens. If, for example, an anti-impact coating is applied, the anti-scratch properties of a second coating applied on top of said first anti-impact coating are diminished due to the softness of the anti-impact coating which is a poor substrate for the anti-scratch coating.

3. To be economically acceptable, a lot of lenses have to be dipped.

4. The coating solution has to be stable enough, i.e. for a few weeks or more, to reduce the economical problem of the need of a large basic volume.

5. The process is a relatively slow process. Generally the layer thickness has to be about 3 micro-meters and so a slow speed of dipping is required.

6. The layer generated is not homogeneous. A variation of the thickness from the top to the bottom of the article dipped is intrinsic to this technology because the top of the substrate is allowed to drain more liquid than the bottom.

7. Another kind of defect found with regard to the homogeneity of the thickness is generated by waves such as waves occurring at the surface of the solution during and due to the dipping movement. This problem can be solved with suitable provisions in the mechanical part allowing the dipping/removing of the lenses, such as e.g. provisions avoiding vibrations.

8. The versatility of this method, due to adhesion problems on different substrates, is poor. If the dip-coating method is performed as a line process, different solutions have generally to be used to reach an acceptable level of adhesion. It is difficult to dip-coat different substrates in one and the same process line without a specific treatment of said varying substrate out of such a line.

The advantage of the dip-coating method is its suitability for mass production.

The spin-coating method:

This method comprises in the deposit of at least one droplet on the center of a substrate, which is then rotated at a quite high speed (some thousands revolutions per minute). This method is far more versatile than the dip-coating method because no bath is required. The spin-coating method allows—if desired—the use of different coatings on the same machine, for example by using different nozzles. However, since the droplet has to be deposited on the center of the substrate, either several substrate holders must be present (one for each nozzle, allowing positioning of the center of each substrate (in suitable distance of each of said nozzles) or a mechanism allowing to move either the nozzles or the substrate relative to each other.

In the scope of the whole specification, the term “center of the substrate” means the center of the surface of a substrate to be coated.

The thickness of the layer depends on the viscosity, the rotation speed and the time of rotation. A general rule is: The longer the time of rotation, or the higher the speed of rotation, or the lower the viscosity of the solution, the thinner the thickness of the layer.

The spin-coating method is already used in ophthalmic processes, e.g. on fully integrated lines.

Nevertheless, some disadvantages of the spin-coating method exist:

1. It consumes a lot of solution for making the layer. The amount of solutions that finally remains as a dried layer is about 25 microliters and the total amount of solution deposited on the ophthalmic lens has to be at least between 1 and 3 milliliter, whereby larger amounts are quite often used. In fact, because of the low viscosity of the deposited solution (about 5 or 10 cps), about 30 droplets have to be put on the substrate (4) surface to ensure a layer that covers the full article with a sufficiently homogeneous layer at the end of the process.

2. The result of the droplets deposition step is strongly dependent on whether a convex or a concave surface has to be coated. Especially when a convex surface has to be coated, the instability of the droplet(s) on the center of the substrate could lead to a flow of a first applied droplet prior to the deposition of a second droplet, thereby leading to a loss of a well positioned efficient amount to be homogeneously distributed by the rotation operation and possibly leading to a defect in the homogeneity of the thickness. Such a defect in the homogeneity of the thickness is depending on the viscosity of the droplet applied and other parameters, such as rotation speed, time of rotation, etc.

3. It is almost impossible to get a homogeneous layer by “on surface generation of the desired mixture” during the deposition process, i.e. by applying droplets of different components or partial mixtures of the finally desired mixture of the coating through different nozzles. Thus, it is only possible to deposit one formulation as droplet and then to spin said formulation to get a layer with uniform composition.

4. When spin-coating methods are used in industry, in general, they are only used for depositing the coating, and said coating is then later on cured somewhere else. Such a procedure, however, bears risks of contamination during the transfer step.

5. Because a larger amount of liquid than finally needed is deposited on the surface to get a proper layer after the spinning step, a lot of liquid is ejected from the surface of the substrate to be covered during spinning, whereby said ejected amount quickly pollutes large parts of the machine. This exceeding amount of liquid is a problem in the process when a lot of substrate have to be coated. Depending on the formulation of the coating used, after a time sufficient to allow at least part of the exceeding amount in the surrounding parts of the apparatus to dry, such dry parts may enter the atmosphere around the substrate to be coated, and act as contaminant for the new layer to be deposited.

The advantage of the spin-coating method is that it allows the developing of processes for the prescription laboratories.

The spray-coating method:

This third coating method is known for applying coatings in industry, e.g. for coating buildings, cars, and in electronics.

This method consists in passing under pressure a liquid through a small nozzle (spray nozzle) in order to create micrometric or even sub-micrometric sized droplets that are projected onto the surface to be coated.

The spray coating has some interesting aspects:

It is possible to deposit thin or thick layers and to locate them quite precisely on a substrate. The loss of liquid coating can be reduced compared to the spin-coating method, and no excessive amount has to be prepared as this is the case in the dip-coating method. However, this technology is not used in the ophthalmic industry for mostly one reason: the film smoothness is not sufficient for the optical application.

Thus, there is still a need for a method to apply thin films of great homogeneity with reduced loss of liquid coating compared to the spin-coating method and the dip-coating method, be it during the coating process or due to aging of a large basic volume needed.

### BRIEF SUMMARY OF THE INVENTION

Hence it is a general object of the invention to provide a coating method that allows the application of one or more layer(s) with homogeneous thickness and low loss of liquid coating. It is a further object of the present invention to provide a device that can be used in said method.

It has now surprisingly be found that the advantages of the spray technique and the spin technique can be combined such as to lead to a method wherein with a minimal amount of liquid coating a homogenous coating is achieved that allows the application of said method for ophthalmic substrates. In said method, the liquid is applied by at least one spray nozzle on a spinning device as e.g. known from spin-coaters. A device suitable for the method of the present invention is also an object of the present invention.

Now, in order to implement these and still further objects of the invention, which will become more readily apparent as the description proceeds, the method for coating a substrate is manifested by the features that at least one liquid coating composition is deposited on a substrate by means of at least one spray nozzle, and that said substrate is rotated (spinned) for some time at least after said liquid coating composition has been deposited. In a preferred embodiment, the substrate is already rotated during the deposition of the liquid coating composition. In another preferred embodiment, the deposition on one side of the lens is made via more than one spray nozzle, wherefrom, of course, all but at most one are in off-center position. This method allows the application of the required amount of liquid coating composition with reduced excess needed. E.g. for a layer corresponding to 25 micro-liters, less than 1 milliliter has to be applied. A further advantage of the method of the present invention is, that a more uniform coating with no irregularities is obtained than with hitherto usual methods. Still a further advantage of the method of the present invention is that several compositions or components of compositions can be deposited in the same step. Such one step deposition can be performed by applying several compositions simultaneously or one directly after the other, i.e. prior to a full or partial curing of the first layer. Such procedure reduces or even eliminates the hitherto observed adhesion problems with different layers applied one after another with interruptions between the deposition steps.

A further object of the present invention is a device that is suitable for performing the above described coating method. Said device comprises (i) at least one support defining, in operating position, a substrate receiving area for receiving a substrate to be coated, said support having an axis, further on termed perpendicular support axis, substantially perpendicular and preferably perpendicular to said substrate receiving area, and (ii) at least on spray nozzle positioned in a distance to said substrate receiving area, and (iii) at least one rotating means for rotating said at least one support around the perpendicular support axis.

In a further embodiment the one or more spray nozzle(s), or part of said spray nozzles, can be moved during the spraying process.

Furthermore, said coating device can have several nozzles e.g. evenly distributed in a radial distance from said perpendicular support axis, or at least two nozzles placed on the same radial line but in different distances from said perpendicular support axis, or on different radial lines and in different distances from said perpendicular support axis.

It is of course preferred that the substrates are round, however any regular shape such as a multi-edged substrate are similarly suitable.

Furthermore, the support can be in a horizontal or in a vertical position, and spray nozzles can be positioned on both sides of the substrate receiving area such as to allow simultaneous coating of both surfaces of said substrate.

The coating device can provide further parts, such as an air providing means that assists the centrifugal forces applied by the rotation and simultaneously adds to the drying of the coating, or an air stream applied to the opposite side of the lens protecting said side from pollution by excess of coating material.

### BRIEF DESCRIPTION OF THE DRAWINGS

The invention will be better understood and objects other than those set forth above will become apparent when consideration is given to the following detailed description thereof. Such description makes reference to the annexed drawings, wherein:

FIG. 1 is a simplified cross section giving the basis of a spray-spin coating apparatus of the present invention with off-centered spray nozzle.

FIG. 2A is a top view of a substrate including a specific form of a holder embodiment.

FIG. 2B is a simplified cross-section through the top of a spray-spin coating apparatus of the present invention comprising the substrate and holder illustrated in FIG. 2A and 2 off-centered spray nozzles, one for a coating A, a second one for a coating B.

FIG. 2C is a diagram showing the flow of coatings A and B over the time whereby the flow is indicated on the y axis and the time on the x axis.

FIG. 3A is a simplified cross-section through the top of a spray-spin coating apparatus of the present invention illustrating a possible arrangement of nozzle and curing device (UV lamp) for generating a thick layer.

FIG. 3B is a diagram showing the sequence and overlap times of the coating (A) and curing (UV) application (y axis) over time (x axis).

### DETAILED DESCRIPTION OF THE INVENTION

The method for coating a substrate 4 of the present invention comprises the steps of depositing at least one liquid coating composition on a substrate 4, preferably a lens, by means of at least one spray nozzle 1, and rotating (spinning) said substrate 4. Said rotation has to be performed for a time after said liquid coating composition has been deposited that is sufficient to generate the desired homogeneous coating all over the substrate 4 or the area to be coated if said area is smaller than the whole area of the substrate. To get a homogeneous coating, it may be preferred that several spray nozzles 1 are suitably distributed over the area to be coated, and/or that the spray nozzle(s) 1 are movable (see below).

In a much preferred embodiment, rotation of the substrate 4 is started prior to the deposition of said liquid coating composition, whereby the rotation speed at the time of deposition can vary from the rotation speed applied later on, or the rotation speed can gradually change, dependent on the coating desired and the characteristics of the one or more liquid coating compositions applied. Also for such an embodiment, it is of course possible to apply the liquid coating composition by means of one or more than one optionally movable spray nozzle(s) 1.

The rotation is performed in that the substrate 4, e.g. a lens, is rotated around an axis substantially perpendicular to the largest projected area of said substrate 4.

Preferably rotation is performed around an axis perpendicular to said largest projected area of said substrate 4, much preferably perpendicular to said largest projected area of said substrate 4 and through the center of said substrate 4.

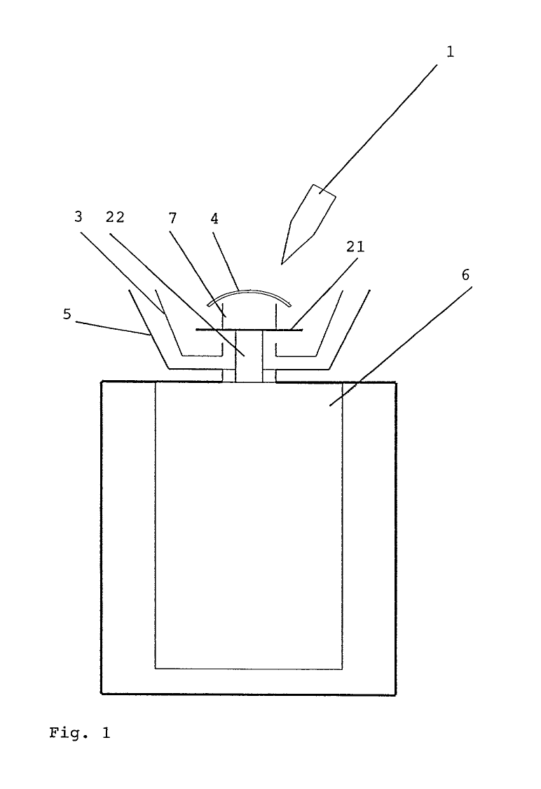

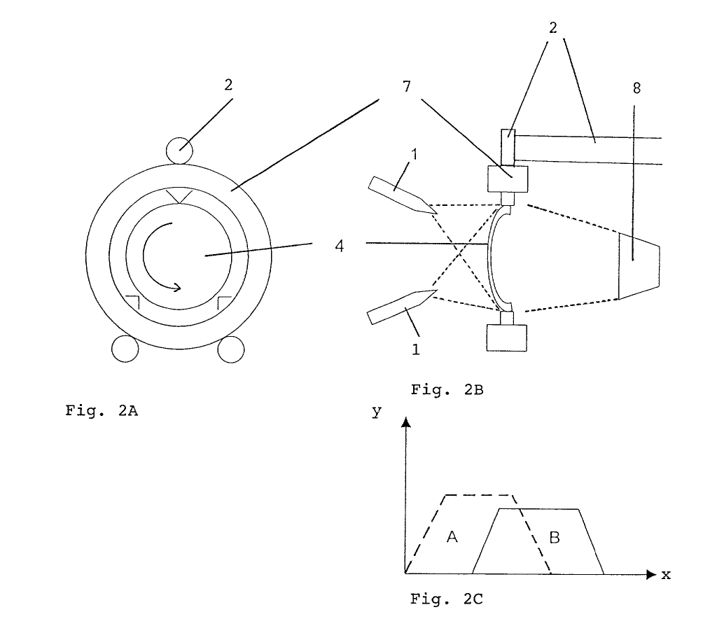

An embodiment of a spray-spin coating device of the present invention with off-centered spray nozzle is shown in FIG. 1. The rotation providing part of said device of FIG. 1 may e.g. be any such part known from spin-coating technology. In the embodiment of FIG. 1, a spinning device wherein the substrate 4 is fixed by means of vacuum is shown. In the embodiment of FIG. 1, no curing means 8 is shown, however, such curing means 8 preferably is present on the same side as the spray nozzle, e.g. in a centered position. In e.g. the embodiment of FIG. 2B—provided that the substrate 4 is transparent to the curing energy—the curing means may also be on the opposite side. A device as described in FIG. 1 comprises a spray nozzle 1, a rotating mechanism 2 (designated in FIG. 1 as 21, 22) to rotate a substrate 4 such as a lens, a removable, preferably even disposable protection 3 to retain and collect excess liquid coating composition and an outer shell or bowl 5 encasing at least part of the actual coating device. Said rotating mechanism 21, 22 to rotate said substrate 4 in the embodiment shown in FIG. 1 not only transfers centrifugal force to the substrate but, due to the specific embodiment comprising a plate 21 connected to a shaft 22, also acts as protection prohibiting excess coating liquid to pollute the part of the device below said plate. Furthermore, said rotating mechanism 21, 22, in particular plate 21, acts as support for the substrate holder or support 7, e.g. a tube connected to a vacuum pump, or a support 7, as specified in FIG. 2A, whereby such circular support 7 may be fixed on the plate 21 by 2 or more thereon fixed legs. Said rotation or centrifugal force respectively, transferred to said substrate by the mechanism 21, 22 is generated by rotation providing means 6, in particular a motor or engine.

In the embodiment of a support 7 shown in FIGS. 2A and 2B, said support 7 comprises a part having circular shape and thereon fixed “clamps”. The inner diameter of said support 7 is larger than the diameter of the substrate and the clamps (represented as sort of triangle) have such a length (optionally adaptable to different substrate diameters) that they bridge the gap between the part having circular shape and the substrate such that they fix, e.g. “clamp”, the substrate. The circular shaped part of said support 7 can be rotated by means of the above described rotating mechanism 21, 22 or by means of a further embodiment of a rotating mechanism 2 as e.g. shown in FIGS. 2A and 2B. The shown embodiment of a rotating mechanism 2 consists of three “legs”, at least one of which and preferably one of which is connected to a motor or engine 6. The further legs are such that they can rotate due to the rotation of the support 7. The leg connected to the motor or engine can be a shaft with a wheel on its top as represented in FIGS. 2A and 2B. Said wheel can either be of a material allowing good transfer of the rotation force to the substrate holder or it may be covered at least on the essential parts by such material, or it may be a gear, whereby in the case of a gear the substrate holder preferably has a thereto matching structure. The legs not connected to rotation providing means 6 (such means is not shown in FIGS. 2A and 2B) may be fixed by any means (not shown) anywhere, provided that the possibility to rotate the substrate 4 is guaranteed.

As it can be seen from the Figures, the rotating mechanism 2 and the support 7 may be fixed on each other, so that the end of one part and the beginning of the other part is floating.

Preferred speeds of rotation of the substrate 4 are 500 to 10000 rpm, more preferred 500 to 5000 rpm.

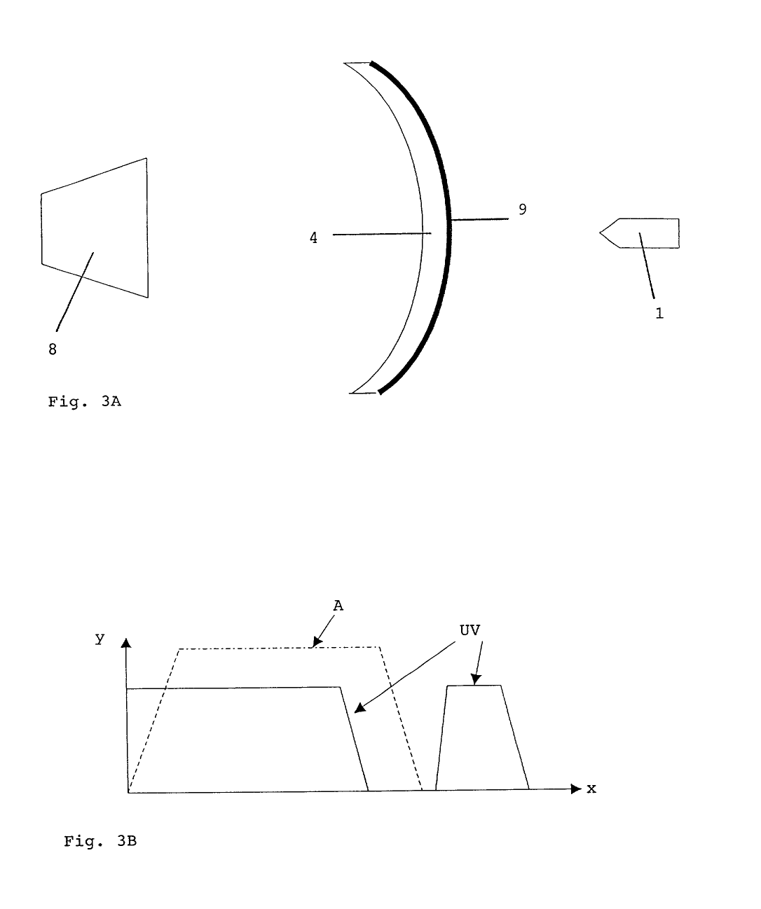

Spray nozzles 1 can be situated above the center of the substrate, i.e. centered (see FIG. 3A) or off-centered (see FIGS. 1 and 2B), whereby at most two spray nozzles 1 can be positioned above the center, namely one on each side of the substrate 4. Such a centered nozzle 1 can be present alone or in combination with further, off-centered spray nozzles 1. It is of course also possible to only use one or, preferably, several off-centered spray nozzles 1 (see FIGS. 1 and 2B). The advantage of a centered nozzle is an optimal use and thus a minimization of the liquid coating composition needed, and the advantage of off-centered nozzles is the possibility to simultaneously use several nozzles (see also below).

Different types of spray nozzles 1 can be used dependent on their place (centered, off-centered), and movement as well as on the coating desired, provided that they generate the needed multitude of small droplets to get the desired smooth surface.

The spray nozzle(s) 1 can be moved in radial direction, preferably away, from the center of said substrate 4, or alternating away from and to said center. It is of course also possible to move said spray nozzle(s) 1 around said center of said substrate 4, or to combine both kinds of movements.

In such movements, e.g. at least two spray nozzles 1 can be moved around said center of said substrate 4, evenly distributed and in identical distance from said center of said substrate 4 (see FIG. 2B), or at least two spray nozzles 1 can be moved around said center of said substrate 4 in different distance to said center and with the same or different revolutions per minute, or at least two spray nozzles 1 can be moved around said center of said substrate 4 in different distance to said center and with the same revolutions per minute, whereby both spray nozzles 1 are positioned on the same radial line extending from said center of said substrate 4.

Several nozzles in the same distance from the center of the substrate 4 are e.g. very well suited to deposit the same liquid coating composition, or to generate a well mixed coating generated by the simultaneous deposition of different coatings or coating components, respectively.

In FIG. 2B an embodiment with a holder 7 as described in FIG. 2A, two off-centered spray nozzles 1 and a curing means 8, e.g. a UV-lamp, is shown. Such an embodiment is suitable for the simultaneous deposition of the same liquid coating composition, or different components of such a liquid coating composition, or for the deposition of two different coating compositions with partly overlapping coating times. A flow (y) vs. time (x) diagram is shown in FIG. 2C, whereby the dashed line curve represents the application of a first liquid coating A, and the continuous line curve represents the application of a second liquid coating B.

It is of course also possible to have several nozzles 1 placed in two or more different distances to the center of the substrate 4, such that their movement describes concentric circles. By such positioning, it is possible to—dependent on the type of nozzle used—improve the fast overall distribution of liquid coating composition.

The same positioning of the nozzles 1 described above, can of course also be chosen in the usual case of fixed, i.e. not moved, nozzles. A similar effect as with several nozzles 1 rotating at the same speed, is e.g. obtained with fixed nozzles 1 and rotated substrate 4. Thus, by rotating the substrate 4 already during the deposition, the presently preferred embodiment, a rotating means for the nozzles can be safed. However, if the substrate 4 is rotated, the distribution by centrifugal forces already during application must be considered and the rotation speed and the deposition speed suitably adapted to avoid inhomogeneous deposition of e.g. two simultaneously applied coatings or coating components with e.g. different viscosities.

Besides of a simultaneous deposition of more than one coating composition, it is of course also possible to apply a first layer and then a second layer and so on. The deposition of several compositions can be performed with an interruption between the prior and the later layer, or, preferably said layers are deposited sequentially, directly one after the other without interruption of the depositions (see e.g. FIG. 2C). By simultaneous or uninterrupted sequential deposition, it is possible to eliminate or at least to markedly reduce, any problems of insufficient adherence.

It is of course within the scope of the present invention to at least partially dry each coating prior to the application of a further layer or at the end of the coating operation to e.g. ensure secure handling.

In view of the homogeneity of the coatings achievable by the method of the present invention, said method is particularly well suited for the coating of ophthalmic substrates 4, in particular ophthalmic lenses, be it in large scale or prescription production or—if thick layers are applied—even for the production of lenses or adaptation of the lens characteristics.

Liquid coating compositions that can be applied comprise but are not limited to compositions providing anti-impact properties, anti-scratch resistance properties, photochromic properties, anti-reflective properties, hydrophobic properties, adhesion properties, UV protection properties, anti-dirtiness properties and color. Of course several such compositions can be applied on one and the same lens, either on the same or on different sides of said lens.

As already mentioned above, the coatings can also comprise an adhesion improving coating, usually known as primer coating, applied prior to any of the afore-mentioned coatings in order to improve the adhesion of a first coating or a substrate 4. Such coatings and primers are known and e.g. described in WO 96/00403 and documents cited therein.

In particular for the deposition of tinted coatings with different color and/or different transmission values, the present invention is of great interest. The inventive method allows the simultaneous application of several compositions due to the presence of several nozzles, and thus easy deposition of variable coatings on any successive, optionally differing substrate 4. Thus, this method is particularly suitable for the prescription laboratories.

The liquid coating compositions for usual coatings are in general applied in amounts corresponding to about 0.1 to 250 microliters of dried layer on a surface of about 50 cm². In general, such coating compositions have a viscosity in the range from about 0.1 to about 2000 cps. For such viscosities, the speed of rotation usually is from about 500 to about 5000 revolutions per minute.

The drying of an applied layer can be performed by any suitable means such as heat, infrared radiation, UV radiation, or any other suitable electromagnetic field. Furthermore, drying can be started during the spraying and/or the spinning, or after said operations, or it can be performed with interruptions. Such curing step can be performed until the layer is entirely cured, or it can be performed to a lower degree, such as a stage of precuring allowing secure handling of the lenses and/or improved adhesion of a second layer due to still reactive groups on the surface of the precured layer allowing interaction with the second layer.

It can also be desirable to get a thicker layer than usually desired and produced by spray-spin-coating. In such cases, where a thicker layer is desired, spraying can be performed with or without spinning but with simultaneous curing. If a certain thickness is generated without spinning or with slow spinning only, it might be necessary or advantageous to apply a last portion of a layer or a last layer with fast spinning to get the desired smoothness of the surface.

By this method not only usual coatings can be applied but even the lens characteristics can be changed, or lenses can be produced if the substrate 4 is a mold instead of the usually preferred lens substrate 4. For such applications dried layers of a thickness of up to about 10 millimeters over the whole or part of a substrate 4, such as a lens or mold, may be suitable.

A specific embodiment for the application of a thick layer 9 is shown in FIG. 3A. In said specific embodiment, the spray nozzle 1 and the curing means 8, e.g. a UV-lamp, are both positioned in a distance of the substrate 4 on an axis perpendicular to the largest projection area of the substrate and going through the center of said substrate 4, but on opposite sides of said substrate 4. For the production of a thick layer 9, it is preferred that the curing energy is already applied from the beginning of the coating to ensure the desired “growing” of the layer, that, however, said curing is stopped prior to the end of the application of the liquid coating to ensure good distribution and thereby smooth surface of the upper part of the layer 9, which is subsequently cured by application of curing energy as soon as the application and distribution of liquid coating has been stopped. Such reaction profile is shown in FIG. 3B with the dashed line showing the flow of liquid coating A (y) vs. the time (x) and the continuous line showing the curing energy UV (y) versus the time (x).

A further object of the present invention is a coating device comprising (i) at least one support 7 defining, in operating position, a substrate receiving area for receiving a substrate 4 to be coated, said support 7 having a perpendicular support axis substantially perpendicular to said substrate receiving area, and (ii) at least one spray nozzle 1 positioned in a distance to said substrate receiving area, and (iii) at least one rotating means 2, 6 for rotating said at least one support 7 around said perpendicular support axis. Said rotation providing means 6 in particular is a motor or engine. Said perpendicular support axis preferably is perpendicular to said substrate receiving area and, in a more preferred embodiment, goes through the center of said substrate receiving area. Said rotating means 2, 6 usually comprises a rotating mechanism 2 and a rotation providing means 6, such as a motor.

In a specific embodiment of the present invention, at least one of said spray nozzle(s) 1 can be moved in a direction radial to said perpendicular support axis with or without tilting.

In yet another embodiment, at least one of said spray nozzle(s) 1 is fixed in place, i.e. no radial movement is possible, but it can be tilted in a direction radial to said perpendicular support axis.

Both embodiments, i.e. the one with radial movement and the one with radial tilting allow to optimize the desired initial distribution of the liquid coating deposited prior to its further distribution due to the rotation of the substrate 4.

It is of course also possible to provide an inventive device with at least one rotating means for rotating at least one of said spray nozzle(s) 1, such as for rotating such a spray nozzle 1 around the perpendicular support axis, or for rotating a spray nozzle 1 around a nozzle rotation axis different from the perpendicular support axis. In the case of a rotation of the nozzle 1, e.g. around the perpendicular support axis, optionally radial movement and/or tilting can additionally be provided, e.g. such that at least one spray nozzle 1 can be moved in radial direction from the perpendicular support axis, as well as rotated either simultaneously, with intervals or one of the movements at a time. Instead of full rotations, it is also possible to provide at least one nozzle 1 with the ability of moving in an area corresponding to a circular segment or an outer part of such a segment. By such an embodiment e.g. specific colour effects can be generated.

It is also possible to provide an inventive coating device with at least two spray nozzles 1 distributed in a radial distance from said perpendicular support axis (see FIG. 2B). The advantage of such a distribution is, that either the deposition speed can be enhanced, or that different compositions or components of compositions can be applied simultaneously, thereby ensuring good mixing of said compositions, in particular if the support 7 is already rotating at the time of deposition.

In yet another embodiment, at least two nozzles 1 are placed on the same radial line but in different distances from said perpendicular support axis.

Besides of at least two spray nozzles 1 placed on the same radial line but in different distances from the perpendicular support axis, it is of course also possible to provide at least two of said spray nozzles 1 placed on different radial lines and in different distances from said perpendicular support axis.

It is of course also possible to provide several groups with two or more spray nozzles 1 in the same radial distance from the perpendicular support axis and on different radial lines forming one group, whereby each such group has another radial distance from the perpendicular support axis.

Summarizing, the general advantages of simultaneously using several spray nozzles 1 on the same side of the substrate 4 is the possibility of good individual regulation of the flow of each nozzle, and therewith for each component; the possibility to easily change the total composition deposited during a specific time, and thereby the thickness of the resulting film; the possibility to generate a gradient of properties in the film thickness; the possibility to deposit several layers of different coating materials, e.g. materials to get for example anti-impact properties and anti-scratch resistance, not only one after the other but in one “combined” coating, or in two partially “overlapping” coatings, thereby reducing, or frequently fully eliminating, the problem of adhesion between two fully separated consecutive layers.

In a preferred embodiment of the present invention the device is provided with at least one curing means 8 enabling the curing of a desired coating during or directly after application of the respective layer. Said at least one curing means 8 can be placed on the same side of the substrate 4 as the surface to be coated or—in the case of a suitable substrate 4 and support 7—the curing means 9 can be placed on the opposite side (see FIG. 2B, 3A). Suitable curing means 9 are e.g. sources for heat, radiation, UV radiation or other electromagnetic fields.

In a further specific embodiment of the present invention, at least one means for a surface treatment is provided such as a means for corona treatment. Such treatment can e.g. be applied in the case that an improved adherence or adhesion, respectively, to a surface is desired. Application of a corona treatment is preferably performed directly prior to the coating operation, i.e. with almost no time gap during which a new undesired layer might be formed. In some cases it might even be desirable to continue corona treatment during the coating operation.

For several reasons it is preferred that the support 7 is designed to hold circular shaped substrates 4. However, any regularly shaped substrate 4 and respectively shaped supports are also applicable with the only disadvantage that either material is lost, or the surface of the substrate 4 is not entirely coated due to the varying distances from the center to the boarder of the substrate 4.

In order to obtain specific effects, it is, however, also possible to use non circular supports, or an irregular orientation of one or more spray nozzles 1 with regard to the perpendicular support axis.

The support 7 itself can have a broad variety of shapes. It can be a tube connected to a vacuum providing device or it can e.g. comprise a holding means of circular shape (for circular substrates 4) and it can be designed such that the substrate 4 can be easily positioned, e.g. in that the circular form in operating position is generated by joining two or more circular segments, or the support 7 can be of a multileg shape with a holding means at the end of each leg (see e.g. FIG. 2A).

Since the rotation forces applied, in general are much greater than the gravitational force, in particular in processes where the substrate 4 is already rotated at the time of deposition of liquid coating composition, it is possible to position the support 7 such that the substrate 4 receiving area usually is in substantially horizontal or in substantially vertical position, whereby for a simultaneous coating of both sides of a substrate 4 a vertical position is preferred, for coating just one of the sides a horizontal position. Thus, the coating device of the present invention can be designed such that the substrate 4 receiving area is in a horizontal or in a vertical position. of course also a position including an angle to either the horizontal or the vertical position is in the scope of the present invention.

It is also within the scope of the present invention that the coating device is integrated in an apparatus providing means to stabilize the support 7 and the nozzles and optionally further parts such as an air providing means, the curing device, protections against pollution of the device 3, casings 5 etc. An embodiment with some of such additional parts is shown in FIG. 1.

For the two side simultaneous coating, the inventive device of course provides a minimum of one spray nozzle 1 on each side of the substrate receiving area, whereby also several nozzles 1 on one or both sides can be provided.

While there are shown and described presently preferred embodiments of the invention, it is to be distinctly understood that the invention is not limited thereto but may be otherwise variously embodied and practiced within the scope of the following claims.

1. A method for coating a substrate wherein at least one liquid coating composition is deposited on a substrate by means of at least one spray nozzle, and wherein said substrate has a largest projected area, and wherein said substrate is rotated (spinned) around an axis almost perpendicular to said largest projected area for some time at least after said liquid coating composition has been deposited.

2. The method of claim 1 wherein said substrate is already rotating when said liquid coating composition is deposited.

3. The method of claim 1 wherein the deposition is made by means of more than one spray nozzle.

4. The method of claim 1, wherein said at least one liquid coating composition is deposited with at least one spray nozzle situated off-center of said substrate.

5. The method of claim 1, wherein said at least one liquid coating composition is deposited with at least two spray nozzles evenly distributed and in identical distance from said center of said substrate.

6. The method of claim 1, wherein said at least one liquid coating composition is deposited with at least two spray nozzles placed in different distances to said center and optionally moved with the same or different revolutions per minute.

7. The method of claim 1, wherein said at least one liquid coating composition is deposited with at least two spray nozzles placed in different distances to said center and on the same radial line extending from said center of said substrate.

8. The method of claim 1, wherein at least one of said spray nozzle(s) is moved radially from the center of said substrate.

9. The method of claim 1, wherein at least one of said spray nozzle(s) is moved around said center of said substrate.

10. The method of claim 1, wherein the substrate is rotated around an axis perpendicular to the largest projected area of said substrate.

11. The method of claim 1, wherein the substrate is rotated around an axis perpendicular to said largest projected area of said substrate, and through the center of said substrate.

12. The method of claim 1, wherein a corona treatment is performed directly prior and or during at least the beginning of the coating operation.

13. The method of claim 1, wherein several compositions or components of compositions are simultaneously deposited.

14. The method of claim 1, wherein several compositions are deposited sequentially, directly one after the other without interruption of the depositions.

15. The method of claim 1, wherein said substrate is an ophthalmic substrate, in particular an ophthalmic lens.

16. The method of claim 1, wherein the one or more liquid coating compositions are selected from the group of compositions providing anti-impact properties, ant-iscratch resistance properties, photochromic properties, anti-reflective properties, hydrophobic properties, adhesion properties, color, UV protection properties, anti-dirtiness and properties and combinations thereof.

17. The method of claim 1 wherein drying or partial drying is performed during and/or after at least one coating operation, with or without interruptions.

18. The method of claim 17 which is performed by application of heat, infrared radiation, UV radiation, or other suitable electromagnetic field.

19. The method of claim 1 wherein at least part of the liquid coating composition is sprayed on a substrate with simultaneous drying and with or without spinning during said spraying and simultaneous drying, provided that in the case without spinning during said spraying and simultaneous drying, spinning is started prior to drying of a last layer.

20. The method of claim 19, wherein said at least part of liquid coating composition is sprayed without spinning or with slow spinning and wherein a last part of said liquid coating composition is then sprayed with fast spinning during or just after spraying and with or without curing during spraying.

21. The method of claim 1, wherein an amount of liquid coating composition corresponding to 0.1 to 250 microliters of dry coating is applied on a surface of 50 cm².

22. The method of claim 1, wherein the speed of rotation, at least after spraying, is from 500 to 10,000 revolutions per minute, preferably from 500 to 5,000 revolutions per minute.

23. The method of claim 1, wherein the viscosity of the liquid coating composition is in the range from 0.1 to 2000 cps.

24. A coating device comprising (i) at least one support defining, in operating position, a substrate receiving area for receiving a substrate to be coated, said support having a perpendicular support axis substantially perpendicular to said substrate receiving area, and (ii) at least one spray nozzle positioned in a distance to said substrate receiving area, and (iii) at least one rotating means for rotating said at least one support around said perpendicular support axis.

25. The coating device of claim 24, wherein said perpendicular support axis is perpendicular to said substrate receiving area.

26. The coating device of claim 24, wherein said perpendicular support axis is perpendicular to said substrate receiving area and located in the center of said substrate receiving area.

27. The coating device of claim 24, wherein at least one of said spray nozzle(s) can be moved in a direction radial to said perpendicular support axis and/or tilted in a direction radial to said perpendicular support axis.

28. The coating device of claim 24, further comprising at least one rotating means for rotating at least one of said spray nozzle(s).

29. The coating device of claim 28, wherein said spray nozzle can be rotated around said perpendicular support axis.

30. The coating device of claim 28, wherein said spray nozzle can be rotated around a nozzle rotation axis different from the perpendicular support axis.

31. The coating device of claim 28, wherein said at least one spray nozzle can be moved in radial direction from the perpendicular support axis, as well as rotated around a support or a nozzle axis either simultaneously, with intervals or one of the movements at a time.

32. The coating device of claim 24, wherein at least two spray nozzles are evenly distributed in a radial distance from said perpendicular support axis.

33. The coating device of claim 24, wherein at least two of said nozzles are placed on the same radial line but in different distances from said perpendicular support axis.

34. The coating device of claim 24, wherein at least two of said spray nozzles are placed on different radial lines and in different distances from said perpendicular support axis.

35. The coating device of claim 24 which comprises at least one curing means.

36. The coating device of claim 35 wherein said curing means is a means for providing heat, infrared radiation, UV radiation or other electromagnetic field.

37. The coating device of claim 24, wherein said support is designed to hold circular shaped substrates.

38. The coating device of claim 24, wherein said substrate receiving area is in a horizontal position.

39. The coating device of claim 24, wherein said substrate receiving area is in a vertical position.

40. The coating device of claim 24 comprising at least two spray nozzles, at least one on each side of the substrate receiving area.

41. A method for coating a substrate by means of a coating device comprising (i) at least one support defining, in operating position, a substrate receiving area for receiving a substrate to be coated, said support having a perpendicular support axis substantially perpendicular to said substrate receiving area, and (ii) at least one spray nozzle positioned in a distance to said substrate receiving area, and (iii) at least one rotating means for rotating said at least one support around said perpendicular support axis, wherein at least one liquid coating composition is deposited on a substrate by means of said spray nozzle, and wherein said substrate has a largest projected area, and wherein said substrate is rotated (spinned) around an axis almost perpendicular to said largest projected area for some time at least after said liquid coating composition has been deposited.
